(19) United States
(12) Patent Application Publication
(10) Pub. No.: US 2004/0002912 A1
(43) Pub. Date: Jan. 1, 2004

(54) System and method for determining product placement in a retail environment

(76) Inventors: Ivette S. Colon, Roseville, MN (US); Kathryn L. Wiemer, Minnetonka, MN (US); Karen A. Wilder, Eden Prairie, MN (US)

Correspondence Address: GENERAL MILLS, INC., P.O. BOX 1113, MINNEAPOLIS, MN, 55440, US

(21) Appl. No.: 10/184,313

(22) Filed: Jun. 27, 2002

(51) Int. Cl. G06F 17/60

(52) U.S. Cl. 705/37

(57) ABSTRACT

The present invention is directed to a method and system used for determining the position or placement of consumer food products in a retail environments. The present invention is useful not only in configuring products for the competitive environment (retail and wholesale) but also is beneficial for other market niche, such as health and fitness marketing and awareness, placement in response to demographic demands and limited or geographic market testing or penetration. The system and method is useable both prior to and subsequent to the introduction of such products and may be used for monitoring the competitive marketplace.

### BACKGROUND OF THE INVENTION

The present invention is directed to a method and system used for determining the position or placement of consumer food products in a retail environment. The present invention is useful not only in configuring products for the competitive environment (retail and wholesale) but also is beneficial for other market niche, such as health and fitness marketing and awareness, placement in response to demographic demands and limited or geographic market testing or penetration. The system and method is useable both prior to and subsequent to the introduction of such products.

There is a constant challenge for marketers and manufacturers to expand market share, increase profitable lines and generate new products as well as to create new interest in existing product offerings. As expected, there is a significant cost associated with the development, introduction and marketing of new products in today's retail and wholesale environments. In addition, current products need to periodically undergo revitalization in order to insure that not only do the product offerings appear fresh but also inviting to today's consumers. However, often times while a particular product may appear to be desirable to the marketing and/or developmental community, the actual introduction of the product into the marketplace results in less than hoped for success, resulting in a significant loss of valuable resources.

Moreover, as stated above, long standing products can often appear stale as there is no periodic review to determine if the marketing and other messages printed on the packages are relevant to current market and consumer trends. For example, certain ingredients may have beneficial health attributes associated with the component. Touting the presence of these ingredients is generally beneficial to manufacturers. However, further research can uncover certain drawbacks associated with such ingredients making it necessary to remove or change related product labeling. The ability of the manufacturer to quickly respond to remove indicia from the packaging is critical but heretofore it is unknown whether such a system is available through which the manufacturer can monitor current developments in fast changing fields such as health related marketing and awareness.

Presently, the current method of evaluating products, whether existing or proposed offerings is done through consumer and other test panels. In these market tests or test panels, products or schematic of products (product concepts) are presented to the panel and the panel is then asked a series of questions to determine the level of interest in a product and the likelihood that the consumer would purchase the product if it was available in their relevant retail marketplace. As part of such tests, the panelist may be required to taste or try product samples and then provide commentary on the samples themselves. Based on the responses that are collected from the market tests or panelists, the manufacturer of the product decides whether to launch the product, refine the messages, packaging or product itself, redevelop the offering or simply scrap the project altogether. If anything other than an immediate launch is decided, the product is then retested and the results surveyed.

The problems associated with the foregoing approaches are numerous. There is the obvious issue of cost, in that each time a product is to be tested an independent marketing firm is usually hired and convenes a panel. Generally, it is thought that using independent research firms and not identifying the actual manufacturer can eliminate product or company biases.

There is the problem of delay, in that the independent research firms require scheduling and then assembling of the product test panels to evaluate the product. Such delay on serves to push off the eventual launch of a product, particularly if additional tests are needed to refine a proposed offering. This delay can cause the manufacturer to miss the available window of opportunity or the currently perceived interest in a product offering. If a product needs to be refined in order to carry current or desirable messages then there is the expense associated with the further development of the product or concept and the packaging to accompany the offering.

Even if the foregoing problems are overcome, that is the results from the market test and panelists would lean in favor of introducing the concept product, the retail or wholesale environment may be already clogged with competitive offerings making introduction of the product an unprofitable situation as the manufacturer may have to compete on price of the offering rather than quality or other attribute, i.e. taste, texture, etc.

Products can also come back from research and seem to have the appearance of a successful fit and appeal to a broad range of audiences, however, the demographics of certain areas of the marketplace may be inappropriate.

Other manufacturers may strive to introduce products that are different or distinctive than that which is currently available in the retail environment. Once a market segment becomes saturated with a product type, there is little value in introducing yet another product that is similar, for instance another chocolate covered energy bar. Moreover, the identification of available shelf space is paramount to the success of such products. If the shelf space is already fully slotted, then unless there is some significant incentive for the retailer or wholesaler to make space available, then regardless of how good a particular offering may be, the product may never reach the store shelves.

Still other problems exist for the manufacturers of retail products. The manufacturer is also required to properly label and mark the products they intend to offer. In addition, manufacturers, in order to be competitive, need to constantly track and monitor competitive product offerings, determine what ingredients and other components are present in their products, the type of packaging and labeling that is necessary, etc.

With all of this various types of data being available, one of the problems with prior solutions was generally the large amount of time required to collect and sort data relevant to a particular retailer's product mix or other objectives. More sophisticated analysis generally requires more data inputs (e.g., demographics, product purchase patterns, etc.). Therefore, such efforts in the past generally involved time-consuming collecting and sorting of static data available from various sources (e.g., store checkout scanners, product category information, demographics information, etc.). This data was then painstakingly analyzed to generate reports showing the retailer information such as the average retail price of the product and generally the rate of sales occurring in other areas which may be geographically related to the particular retailer.

The process of collecting, sorting and preparing the necessary data could often take anywhere from 40 to 200 hours. Because pulling data is so time-consuming, product category management analysts found they were spending most of their time just pulling data. Sometimes, this left insufficient time to analyze what the data meant, what action items should be taken, and what areas required further analysis.

Additionally, the typically time-consuming data collection process would often tie up valuable marketing and sales resources. Sometimes, there would not be enough time to do the steps needed to create an appropriate report in time for a seasonal or promotional event in which a particular retail account may be interested in participating. It was sometimes difficult to meet deadlines for a periodic account review—wasting opportunities and efforts.

In addition, it was generally not possible to quickly integrate additional data sources or information into data collection efforts to provide a more comprehensive analysis because to do so would increase the time required. Thus, such efforts could often fail to identify targets, market or segment gaps or goals that a retailer should strive to achieve (and which may not be readily apparent). The resulting reports sometimes provided only raw, fixed numbers relating to actual sales, but with no breakdown or other detailed analysis (e.g., through demographic modeling) of how those sales were achieved. Such reports were of limited usefulness.

A further complication is that many of the data sources are constantly being updated and changed. For example, standard data sources are periodically updated, and a new data is added from time to time to the particular category of interest. After such a monumental collecting and sorting effort, the ultimate report—even assuming it was available in time to be presented to the retailer—could easily be based on stale or out-of-date data or information.

As such, what is needed is a system and method for identifying current trends in the marketplace as well as the ability to capitalize on current competitive, nutritional and health needs of the population or particular demographics. What is also needed is a system, which can readily provide updated packaging information when new labeling requirements are mandated or changes in research dictate the necessity of a change. Such a system would enable the successful introduction of new products into a stable or growing niche category or SIC code, maintain market share of existing products and reduce the risk of product introduction when done with limited information as in the past.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The system includes various data sets that are housed in one or more databases that store particular attributes of a product. Such data sets may include a general product description, macro and micronutrient content, nutritional value, ingredient listings, flavor categorization, health or nutrition claims, other claims, portion or serving size, package structure, package weight and content, manufacturer name, brand, trade name or trademark, calories as well as other relevant fields to the particular product category or such other labeling as may be required by statute or local laws or ordinances. The system may also be connected to one or more remotely located databases that would provide additional detail such as demographic information, competitive sales data, recent product and press releases.

In using the present invention prior to product placement or introduction a hypothetical product into a specific category or SIC code, one or more of the individual data sets contained in a database are queried to determine competitive pressures, shelf position or status against other products already appearing in the same category or SIC code. Based on the results of the query, the product type can be adjusted according to one or more of the attributes that are stored in the database to provide a product that will be competitive. In addition, the system of the present invention can also be used to determine the correct current marketing information, health related indicia and other mandatory labeling.

The present invention provides for a system that enables the benchmarking of existing and proposed products in a comparative situation with current or former products in the retail environment. The system includes a series of unique databases that track individual categories or groups of ingredients or other data sets, such as health information, nutritional and labeling requirements. Additional data can be supplied from external data sources such as sales penetrations and market share of third party products. A computing means is used to extract information from the databases in order to create a reporting summary which will identify commercial areas or gaps that can be exploited with new product introductions or re-launches of existing products. In addition the system can be used to provide the manufacturer with a listing of current indicia that may be required to appear on the packaging.

In one preferred embodiment of the present invention, an automated product placement tool is described and comprises a database that has a plurality of distinct data sets. At least one of the data sets contains claims information on consumer products and at least another of the data sets contains ingredient information. A first input module that is capable of receiving data from at least one of the data sets in response to a user of the tool. The input module provides end user data to the database to create a comparative analysis for the end user. The system also includes a first output module that displays the analysis of the end user data in comparative association with at least one of the data sets. The comparative analysis creates a product placement plan to stimulate product sales.

A still further embodiment of the present invention relates to a system for determining product placement of product offerings, is described and comprises a product database for consumer products provided at a first location and containing a number of data sets. At least one remote database is provided and contains demographic information related to the consumer products. A communication arrangement that connects the at least one remote terminal to the product database. An input module that solicits information from the product database and the remote database. An output module for generating analysis created from the solicitation. The analysis that is generated by the system provides an indication of the likelihood of success of the new product offering.

A yet still further embodiment of the present invention relates to method for determining product placement in commercial outlet. The method of the present invention comprising the steps of initially providing at least a first, second and third data sets in a first database. The first data set has a listing of ingredient information. The second data set has a listing macronutrients and micronutrients, and the third data set contains claims information. Once the data sets have been provided, data is obtained from the data sets contained within the first database. The data is then analyzed to provide information related to a competitive retail environment. From that analysis a report or output is generated to determine the likelihood of product placement success in the competitive retail environment.

A still further embodiment of the present invention relates to a method of tracking competitive product offerings to determine product placement. That method comprising the steps of initially providing a number of distinct data sets within at least a first database. Using at least one of the distinct data sets within the first database in response to an end user query to develop a product placement plan. Then the information is displayed in a summary format in response to the end user query. Next, information is obtained from a second database distinct from the first database. Finally, the information obtained from the second database is merged with the product placement plan to create an updated product placement plan.

These and other objects of the invention will become clear from an inspection of the detailed description of the invention and from the appended claims.

### BRIEF DESCRIPTION OF THE DRAWINGS

The above-mentioned embodiments, as well as other objects and advantages of this invention, will be more completely understood and appreciated by referring to the following more detailed description of the presently preferred exemplary embodiments of the invention in conjunction with the accompanying drawings, of which:

FIG. 1 is a schematic representation of the product placement tool;

FIG. 2 is a flow diagram illustrating a preferred embodiment of the present invention; and

FIG. 3 is a flow diagram illustrating another preferred embodiment of the present invention.

### DETAILED DESCRIPTION OF THE INVENTION

The present invention relates to a tool and a method of using the system embodied in the tool to create a product placement or positioning plan in commercial outlets. As used herein the term commercial outlets refers not only to retail, supermarkets, department stores, superstores, pharmacies and the like but also wholesale outlets, such as warehouse clubs.

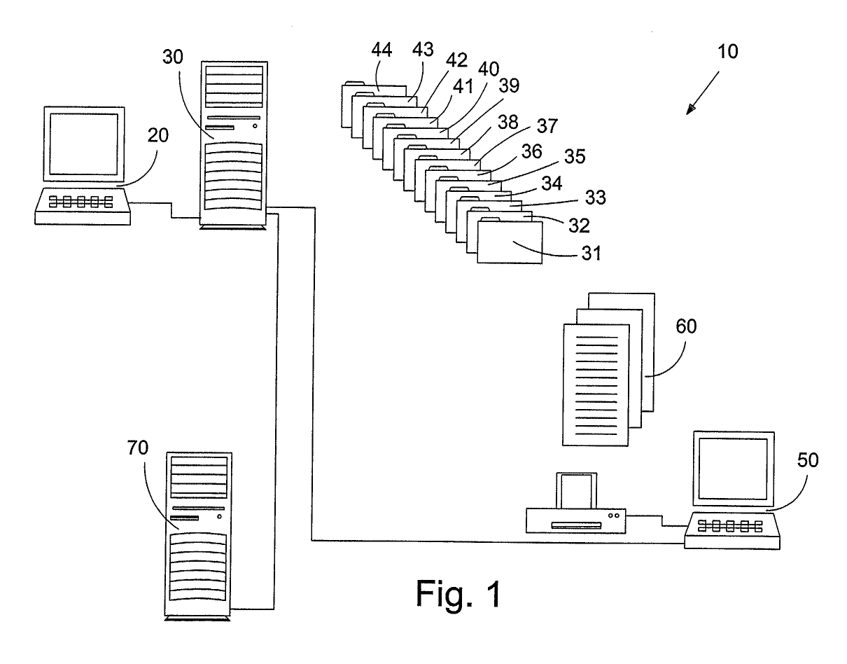

The tool and system of the present invention can be illustrated further by turning to FIG. 1, which provides a schematic illustration of the system configuration. The tool or system is generally illustrated by reference numeral 10. The tool 10 includes a user input module 20 that is configured to enable and end user to input data, request queries and format data received. The input module 20 is connected to at least a first database 30. The first database 30 has a number of individual or discrete datasets, labeled as 31 through 39.

Each of the data sets 31 through 43 include discrete information relating to general product description 31, macro and micronutrient content 32, nutritional value 33, ingredient listings 34, flavor categorization 35, health, nutrition or health awareness claims 36, regulatory or government required claims 37, product portion or serving size 38, package structure 39, package weight and content 40, manufacturer name 41, brand, trade name or trademark 42, calories 43 as well as other relevant fields 44 to the particular product category or such other labeling as may be required by statute or local laws or ordinances, such as additional language requirements.

The general product description data set 32 would contain relevant information to the product category. For example, if the product were a ready to eat (RTE) cereal the product description may provide oat based, shaped, children's RTE cereal.

The macronutrient and micronutrient data set 32 would include the listing of various vitamins and minerals. Essential nutrients which might be tracked include but is not limited to the following: Fat; saturated fat; cholesterol; sodium; potassium; carbohydrates; dietary fiber; sugars; protein; vitamin A; vitamin C; calcium; iron; vitamin D; vitamin E; vitamin K; thiamine; riboflavin; niacin; vitamin B6; biotin; pantothenic acid; phosphorus; iodine; magnesium; zinc; selenium; copper; manganese; chromium; molybdenum; chloride; folate; vitamin B12; and selenium.

The nutritional values data set 33 may include the U.S. recommended daily values (“USRDV” or “DV”) of each of the macronutrients and micronutrients present in the product offering and competitive product offerings and may include further information on the DV required for a complete balanced diet. This data set identifies whether or not the product (i.e., RTE cereals) meet the Federal requirements for eligibility for the Supplemental Nutrition Program for Women, Infants and Children (WIC).The ingredient data set 34 includes information and listing pertaining to ingredients contained within the product offering and competitive product offerings. Such ingredients would include flour, salt, water, preservatives, natural and artificial colors, fruit and nut pieces, oils, starches, syrups, oats, grains, meats, dairy products and the like.

The flavor categorization data set 35 may include items like chocolate, licorice, fruit and vegetable flavors, peanut butter, teas, nuts and grains, desert flavors, candy flavors and the like.

The claims information data sets include one data set 36 that provides nutritional or health awareness claims and the other claims data set 37 provides regulatory or other governmentally or required labeling. Such health related claims relate to such suggestions as eating this product may help lower cholesterol, reducing the risk of cardiovascular diseases and some cancers. Regulatory labeling may include such items as not for children under a certain age, warnings about use of machinery after taking the product and the like.

The product or serving size data set 38 relates to the particular serving size. For instance, an RTE cereal may have a 30-gram serving size and there may be twelve servings per container. (Cereal database does not provide information on servings per container. It does however; provide the household measurement of a serving.)

The packaging structure data set 39 includes such items as whether the product is in a bag, paperboard carton, can, foil lined container, plastic receptacle, squeezable tube, single use container, portable container and the like.

The data set related to package weight and content 40 would include details specific to the product size, whether there are multiple products per package, if the product is packaged for distribution through wholesale environments such as with a pallet or shrink wrapped arrangement of 3 or more products per package group.

The manufacturer name data set 41 would include the actual manufacturer of the product offering, whether the product is offered by the manufacturer directly or whether it is a private label or contract manufacture product.

The brand, trade name or trademark data set 42 lists the names under which a product offering may be identified, names the product may have been known previously and derivations on the name itself.

The calorie data set 43 provides information on the calories per serving size, calories across different brand or related groups and competitive offerings.

Other relevant data sets 44 may include other required labeling such as directions for use in plural languages, high altitude cooking instructions, whether premiums or prizes have been offered along with the offering, manufacturing locations, etc.

The database 30 is connected to the input module 20 via a local area network, however the interconnection may occur over wide area network, intranet or Internet depending on the needs or capabilities of the system 10 and supporting infrastructure.

The input module 20 is used to generate queries and retrieve information from at least one of the data sets 31 to 44 contained within database 30. The input module 20 receives data from one of the data sets 31-44 in the database 30 in response to the query or request generated by the user of the tool 10. The data that is provided by the tool 10 through use of the database 20 creates a comparative analysis between the product (if it is an existing product) or product concept (if it is a new product) and the competitive landscape in which the product will be placed or positioned.

The input module 20 is connected to an output module 50, which is used to display the comparative analysis generated in connection with the end user query. The output module 50 may include a printer, monitor or other means suitable for displaying information. The output module 50 may be at the same location as the input module 20 or may be at a remote location. The comparative analysis created by the output module 50 is then used to create a product placement plan 60.

The system or tool 10 of the present invention may include a second database 70. The second database 70 may provide access to information that is provided on a subscription or contract basis. For example, it is possible to purchase or license useful data sets from a variety of sources including for example A.C. Nielsen, Spectra Marketing, and others. For example, A.C. Nielsen provides so-called consumer panel data that supplies consumer purchase information based on diaries and the like. A.C. Nielsen also provides SCANTRACK and Market Dimension data sets that track consumer purchases in a given market through data collection based on in-store checkout scanners. Spectra Marketing provides demographic-based consumer information that can be used to develop sales and in-store marketing strategies. Some retailers also use planograms (i.e., graphical shelf space layout plans) to assist in retail product placement. All of these various data sources can be useful in product category analysis. Of course, for non-AC Nielsen accounts different databases and data sources (e.g., internally developed data sources) could be used instead.

If information is obtained from the second database 70 which may be provided at a remote location, the product placement plan 60 is update to include the information obtained from the second database 70. That plan may include such other features as a planogram, which illustrates the placement or positioning of the product at the retail or wholesale location.

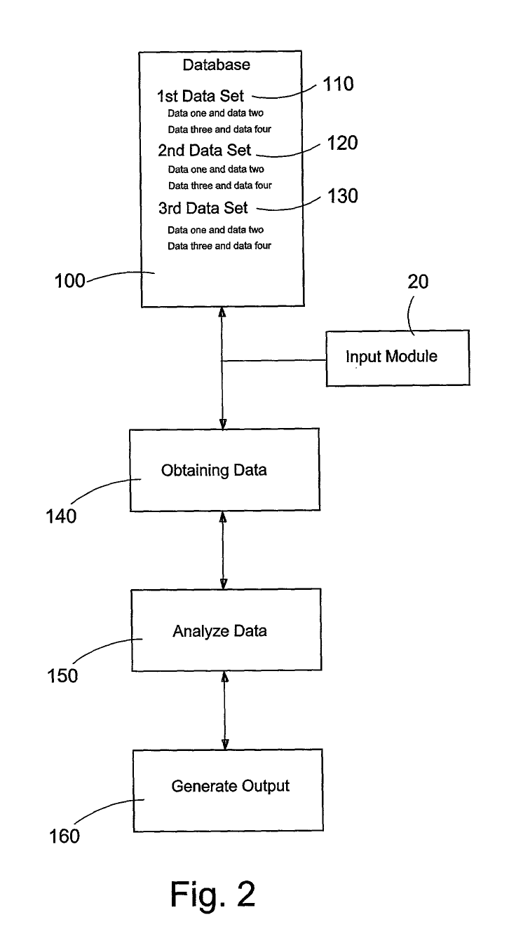

In one embodiment for using tool or system of the present invention, a flow diagram is depicted in FIG. 2. In FIG. 2, at least first through third data sets 110, 120 and 130 are provided in a database 100. Data at step 140 is obtained from the database 100 by using an input module. Once the data 140 has been acquired the next step is to analyze the results, which occurs in step 150. The analysis focuses on information related to the retail environment. Retail environment refers generally to an environment where direct to consumer sales occur.

Once the analysis in step 150 has been completed and any refinements made to the information, an output is generated in step 160. This output generally includes a product placement plan.

As used herein, the term product placement plan, refers generally to the look and possible feel of the product being considered using the tool. The product placement plan includes a listing of all the information queried from the specific data sets which ranges from ingredients, to portion sizes, to claims labeling to packaging.

For example, the product placement plan may create the following exemplary data set.

| Nutrient/Component | | |
|---|---|---|
| Ingredient | Health Issue | Structure Function Indicia |
| Beta Glucan | Heart Disease; | May help to maintain a Cholesterol |
| healthy | | |
| | Cholesterol | Cardiovascular system; (2) useful in the |
| | | maintenance/of a healthful blood |
| | | cholesterol level; (3) as part of a heart- |
| | | healthy diet; (4) the soluble fiber |
| | | In Cheerios ® can reduce your cholesterol. |
| B Complex Vitamins | Energy Metabolism | Important to the activity of many |
| enzymes | | and in energy metabolism. |
| Calcium | Bone Development | Important/critical to growing strong and |
| | | healthy bones. |

| Classification | Reference Notes | Regulatory Status |
|---|---|---|
| Other | ABC | GRAS |
| Vitamin | ABC | GRAS |
| Mineral | ABC | GRAS |

The term “other” is used in the above example as a miscellaneous class representation as Beta Glucan, a dietary fiber, is not a recognized member of another class such as a vitamin or mineral. Under “reference notes” the applicant has simply provided a generic listing of a reference source (“ABC”). Regulatory status for Beta Glucan is “GRAS” or Generally Recognized as Safe and was obtained via a producer or supplier of the material rather than an approval of a governmental agency.

Proposed Recommended Daily Value (“DV”)

| | |
|---|---|
| Total Fat | 5% |
| Saturated Fat | 3% |
| Cholesterol | 0% |
| Sodium | 10% |
| Potassium | 5% |
| Total Carbohydrate | 14% |
| Dietary Fiber | 17% |
| Protein | 10% |
| Vitamin A | 10% |
| Vitamin C | 70% |
| Calcium | 0% |
| Iron | 80% |
| Vitamin D | 10% |
| Vitamin E | 100% |
| Thiamin | 100% |
| Riboflavin | 80% |
| Niacin | 80% |
| Vitamin B6 | 80% |
| Folic Acid | 100% |
| Vitamin B12 | 100% |
| Phosphorus | 15% |
| Magnesium | 10% |
| Zinc | 80% |
| Copper | 4% |

The product placement plan may also include planogram information as indicated previously and as set forth below.

[image]

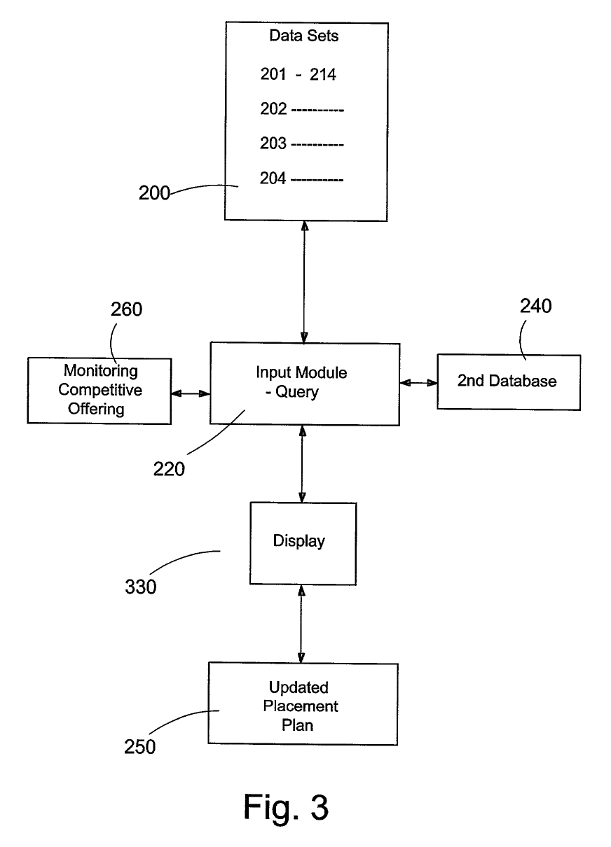

A further method of using the tool of the present invention is illustrated in the flow diagram of FIG. 3. In this method, a method of tracking a competitive offering is described and includes the steps of 200 providing a number of distinct data sets. The data set may be the similar sets as described and shown in FIG. 1 with reference to items 201-214 or may comprise additional data sets useful in tracking relevant information pertaining to the particular category of interest.

Data is obtained from the database 200 based on a query generated from an input module illustrated at step 220. A display 230 is created in response to the data that has been presented. Next, a second database 240 is utilized to provide additional information relevant to a query and that information is merged to provide an updated placement plan 250.

The above-mentioned methodology may include the further steps of being able to monitor the new launches and releases of competitive products 260 and then being able to revise the product placement plan based on that further information.

The product placement plan can be used in analyzing the types of packaging that is currently being used by competitive offerings. This assists the marketing and sales organization in preparing packaging that will be distinctive or meet a particular need or fill a specific niche in the category that the product is being placed. The packaging may include a new paperboard box construction and suggest that premiums offered with such products in the past have spurred additional sales. The method and tool may reveal a growing trend in single serve or portable packaging.

Another feature offered by the present invention is the aid in structuring a marketing or advertising plan and communicating the information created by the placement plan. For example, if a health awareness claim is generated and indicates that the product will aid in the reduction of cholesterol, that message has a perceived benefit to the population that is concerned with maintenance of a healthy life style.

With the re-launch or re-marketing of existing products, new health claims can be added to packaging based on data collected in the health claims area. This permits an existing product to realize a newly discovered benefit of an existing ingredient or other nutrient, which the product may have previously contained but was not exploited. In addition, such existing products may also be subsequently become fortified with certain vitamins or minerals due to recent research or discoveries of beneficial interactions. Thus, the present invention is also useful in monitoring and updating products that are already present in the retail environment.

It will thus be seen according to the present invention a highly advantageous system and method for determining product placement has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. An automated product placement tool comprising;
a database having a plurality of distinct data sets, at least one of said data sets containing claims information on consumer products and at least another of said data sets containing ingredient information;
a first input module capable of receiving data from at least one of said data sets in response to a user of said tool; said input module providing end user data to said database to create a comparative analysis for said end user;
a first output module for displaying said analysis of said end user data in comparative association with at least one of said data sets; and
wherein said comparative analysis creates a product placement plan to stimulate product sales.

2. An automated product placement tool as recited in claim 1, wherein said database contains al data set relating to macronutrient and micronutrient content.

3. An automated product placement tool as recited in claim 1, wherein said database contains a data set relating to claims information.

4. An automated product placement tool as recited in claim 3, wherein said claims data set includes information relating to health based claims.

5. An automated product placement tool as recited in claim 3, wherein said claims data set includes information relating to regulatory requirements.

6. An automated product placement tool as recited in claim 1, wherein a second database is provided and contains demographic information and said second database is at remote location.

7. An automated product placement tool as recited in claim 1, wherein said first input module, said database and said first output module are connected over a local area network.

8. A system for determining product placement of product offerings, comprising;
a product database for consumer products provided at a first location and containing a number of data sets;
at least one remote database for providing demographic information related to said consumer products;
a communication arrangement connecting said at least one remote terminal to said product database
an input module for soliciting information from said product database and said remote database;
an output module for generating analysis created from said solicitation; and
wherein said analysis provides an indication of the likelihood of success of said new product offering.

9. A system for determining product placement of product offerings as recited in claim 8, wherein at least one of said data sets contains health claim information.

10. A system for determining product placement of product offerings as recited in claim 8, wherein one of said data sets contains regulatory claim information.

11. A system for determining product placement of product offerings as recited in claim 8, wherein said communication arrangement is a local area network.

12. A system for determining product placement of product offerings as recited in claim 8, wherein said analysis includes a product placement plan.

13. A method for determining product placement in commercial outlets, comprising the steps of;
providing at least a first, second and third data sets in a first database;
said first data set having a listing of ingredient information, said second data set having a listing macronutrients and micronutrients, and said third data set containing claims information;
obtaining data from said data sets contained within said first database;
analyzing said data to provide information related to a competitive retail environment; and
generating an output to determine likelihood of product placement success in said competitive retail environment.

14. A method for determining product placement in commercial outlets as recited in claim 13, wherein said claims information in said third data set are health awareness claims.

15. A method for determining product placement in commercial outlets as recited in claim 13, wherein said claims information in said third data set are regulatory claims.

16. A method for determining product placement in commercial outlets as recited in claim 13, wherein said method includes the further step of providing at least fifth and sixth data sets.

17. A method for determining product placement in commercial outlets as recited in claim 16, wherein said fifth data set includes information on product serving size.

18. A method for determining product placement in commercial outlets as recited in claim 16, wherein said sixth data set includes information on product flavor types.

19. A method of tracking competitive product offerings to determine product placement, comprising the steps of;
providing a number of distinct data sets within at least a first database;
using at least one of said distinct data sets within said first database in response to an end user query to develop a product placement plan;
displaying information in a summary format in response to said end user query;
obtaining information from a second database distinct from said first database; and
merging said information obtained from said second database with said product placement plan to create an updated product placement plan.

20. A method of tracking competitive product offerings to determine product placement as recited in claim 19, comprising the further steps of a) monitoring competitive offerings and b) further revising said updated product placement plan.

21. A method of tracking competitive product offerings to determine product placement as recited in claim 19, wherein said information obtained from said second database is claims information.

22. A method of tracking competitive product offerings to determine product placement as recited in claim 19, wherein said claims information includes health awareness claims.

23. A method of tracking competitive product offerings to determine product placement as recited in claim 19, wherein said claims information includes regulatory information.

24. A method of tracking competitive product offerings to determine product placement as recited in claim 19, wherein said updated product placement plan is used to design packaging.

25. A method of tracking competitive product offerings to determine product placement as recited in claim 19, comprising the further step of communicating said updated product placement plan to a consumer audience as part of an advertising campaign.

26. A method of tracking competitive product offerings to determine product placement as recited in claim 19, wherein said information in said second database is demographic information.

27. A method of tracking competitive product offerings to determine product placement as recited in claim 19, wherein said updated product placement plan includes a planogram depicting in store product positioning.
